(19) United States
(12) Patent Application Publication
(10) Pub. No.: US 2007/0166554 A1
(43) Pub. Date: Jul. 19, 2007

(54) Thermal interconnect and interface systems, methods of production and uses thereof

(76) Inventors: Brian D. Ruchert, Newman Lake, WA (US); Patrick K. Underwood, Spokane, WA (US); Xingcun Tong, Greenacres, WA (US)

Correspondence Address: BUCHALTER NEMER, 18400 VON KARMAN AVE., SUITE 800, IRVINE, CA, 92612, US

(21) Appl. No.: 11/334,637

(22) Filed: Jan. 18, 2006

(51) Int. Cl. B32B 13/04

(52) U.S. Cl. 428/446

(57) ABSTRACT

Components and materials, including thermal transfer materials, described herein comprise at least one heat spreader component coupled with a metal-based coating, layer and/or film, at least one thermal interface material and in some contemplated embodiments at least one adhesive material. The heat spreader component comprises a top surface, a bottom surface and at least one heat spreader material. The thermal interface material is directly deposited onto at least part of at least one of the surfaces of the heat spreader component. Methods of forming layered thermal interface materials and thermal transfer materials include: a) providing a heat spreader component, wherein the heat spreader component comprises a top surface, a bottom surface and at least one heat spreader material; b) providing at least one thermal interface material, wherein the thermal interface material is directly deposited onto the bottom surface of the heat spreader component; c) depositing, applying or coating a metal-based coating, film or layer on at least part of the bottom surface of the heat spreader component; and d) depositing, applying or coating the at least one thermal interface material onto at least part of at least one of the surfaces of the heat spreader component. A method for forming the thermal solution/package and/or IC package includes: a) providing the thermal transfer material described herein; b) providing at least one adhesive component; c) providing at least one surface or substrate; d) coupling the at least one thermal transfer material and/or material with the at least one adhesive component to form an adhesive unit; e) coupling the adhesive unit to the at least one surface or substrate to form a thermal package; f) optionally coupling an additional layer or component to the thermal package.

### FIELD OF THE INVENTION

The field of the invention is thermal interconnect systems, thermal interface systems and interface materials in electronic components, semiconductor components and other related layered materials applications.

### BACKGROUND

Electronic components are used in ever increasing numbers in consumer and commercial electronic products. Examples of some of these consumer and commercial products are televisions, personal computers, Internet servers, cell phones, pagers, palm-type organizers, portable radios, car stereos, or remote controls. As the demand for these consumer and commercial electronics increases, there is also a demand for those same products to become smaller, more functional, and more portable for consumers and businesses.

As a result of the size decrease in these products, the components that comprise the products must also become smaller. Examples of some of those components that need to be reduced in size or scaled down are printed circuit or wiring boards, resistors, wiring, keyboards, touch pads, and chip packaging. Products and components also need to be prepackaged, such that the product and/or component can perform several related or unrelated functions and tasks. Examples of some of these “total solution” components and products comprise layered materials, mother boards, cellular and wireless phones and telecommunications devices and other components and products, such as those found in U.S. Patent and PCT Application Serial Nos.: 60/396294 filed Jul. 15, 2002, 60/294433 filed May 30, 2001 and PCT/US02/17331 filed May 30, 2002, which are all commonly owned and incorporated herein in their entirety.

Components, therefore, are being broken down and investigated to determine if there are better building materials and methods that will allow them to be scaled down and/or combined to accommodate the demands for smaller electronic components. In layered components, one goal appears to be decreasing the number of the layers while at the same time increasing the functionality and durability of the remaining layers. This task can be difficult, however, given that several of the layers and components of the layers should generally be present in order to operate the device.

Also, as electronic devices become smaller and operate at higher speeds, energy emitted in the form of heat increases dramatically. A popular practice in the industry is to use thermal grease, or grease-like materials, alone or on a carrier in such devices to transfer the excess heat dissipated across physical interfaces. Most common types of thermal interface materials are thermal greases, phase change materials, and elastomer tapes. Thermal greases or phase change materials have lower thermal resistance than elastomer tape because of the ability to be spread in very thin layers and provide intimate contact between adjacent surfaces. Typical thermal impedance values range between 0.05-1.6° C.-cm²/W. However, a serious drawback of thermal grease is that thermal performance deteriorates significantly after thermal cycling, such as from −65° C. to 150° C., or after power cycling when used in VLSI chips. It has also been found that the performance of these materials deteriorates when large deviations from surface planarity causes gaps to form between the mating surfaces in the electronic devices or when large gaps between mating surfaces are present for other reasons, such as manufacturing tolerances, etc. When the heat transferability of these materials breaks down, the performance of the electronic device in which they are used is adversely affected.

Thus, there is a continuing need to: a) design and produce thermal interconnects and thermal interface materials, layered materials, components and products that meet customer specifications while minimizing the size of the device and number of layers; b) produce more efficient and better designed materials, products and/or components with respect to the compatibility requirements of the material, component or finished product; c) develop reliable methods of producing desired thermal interconnect materials, thermal interface materials and layered materials and components/products comprising contemplated thermal interface and layered materials; d) develop materials that possess a high thermal conductivity and a high mechanical compliance; and e) effectively reduce the number of production steps necessary for a package assembly, which in turn results in a lower cost of ownership over other conventional layered materials and processes.

### SUMMARY

Components and materials, including thermal transfer materials, contemplated herein comprise at least one heat spreader component coupled with a metal-based coating, layer and/or film, at least one thermal interface material and in some contemplated embodiments at least one adhesive material. The heat spreader component comprises a top surface, a bottom surface and at least one heat spreader material. The thermal interface material is directly deposited onto at least part of at least one of the surfaces of the heat spreader component.

Methods of forming layered thermal interface materials and thermal transfer materials include: a) providing a heat spreader component, wherein the heat spreader component comprises a top surface, a bottom surface and at least one heat spreader material; b) providing at least one thermal interface material, wherein the thermal interface material is directly deposited onto the bottom surface of the heat spreader component; c) depositing, applying or coating a metal-based coating, film or layer on at least part of the bottom surface of the heat spreader component; and d) depositing, applying or coating the at least one thermal interface material onto at least part of at least one of the surfaces of the heat spreader component.

A method for forming the thermal solution/package and/or IC package includes: a) providing the thermal transfer material described herein; b) providing at least one adhesive component; c) providing at least one surface or substrate; d) coupling the at least one thermal transfer material and/or material with the at least one adhesive component to form an adhesive unit; e) coupling the adhesive unit to the at least one surface or substrate to form a thermal package; f) optionally coupling an additional layer or component to the thermal package.

### BRIEF DESCRIPTION OF THE FIGURES

FIG. 1 shows a contemplated thermal transfer material and a contemplated press assembly.

FIG. 2A shows a contemplated thermal transfer material and a contemplated press assembly.

FIG. 2B shows a contemplated thermal transfer material.

FIG. 3 shows part 1 of a contemplated process map for forming a thermal transfer material and/or combo-spreader component.

FIG. 4 shows part 2 of a contemplated process map for forming a thermal transfer material and/or combo-spreader component.

FIG. 5 shows part 3 of a contemplated process map for forming a thermal transfer material and/or combo-spreader component.

FIG. 6 shows a process flow chart and schematics for a contemplated thermal transfer material and/or combo-spreader component.

FIG. 7A shows a contemplated embodiment with a stamped die and stamped thermal transfer material.

FIG. 7B shows the stamped thermal transfer material from another perspective.

FIG. 8 shows a contemplated thermal transfer material.

FIG. 9 shows a contemplated thermal transfer material.

### DETAILED DESCRIPTION

A suitable interface material or component should conform to the mating surfaces (“wets” the surface), possess a low bulk thermal resistance and possess a low contact resistance. Bulk thermal resistance can be expressed as a function of the material's or component's thickness, thermal conductivity and area. Contact resistance is a measure of how well a material or component is able to make contact with a mating surface, layer or substrate. The thermal resistance of an interface material or component can be shown as follows:
Θ interface=t/kA+2Θ_{contact} Equation 1
where
Θ is the thermal resistance,
t is the material thickness,
k is the thermal conductivity of the material
A is the area of the interface

The term “t/kA” represents the thermal resistance of the bulk material and “2Θ_{contact}” represents the thermal contact resistance at the two surfaces. A suitable interface material or component should have a low bulk resistance and a low contact resistance, i.e. at the mating surface.

Many electronic and semiconductor applications require that the interface material or component accommodate deviations from surface flatness resulting from manufacturing and/or warpage of components because of coefficient of thermal expansion (CTE) mismatches.

A material with a low value for k, such as thermal grease, performs well if the interface is thin, i.e. the “t” value is low. If the interface thickness increases by as little as 0.002 inches, the thermal performance can drop dramatically. Also, for such applications, differences in CTE between the mating components causes the gap to expand and contract with each temperature or power cycle. This variation of the interface thickness can cause pumping of fluid interface materials (such as grease) away from the interface.

Interfaces with a larger area are more prone to deviations from surface planarity as manufactured. To optimize thermal performance, the interface material should be able to conform to non-planar surfaces and thereby lower contact resistance. As used herein, the term “interface” means a couple or bond that forms the common boundary between two parts of matter or space, such as between two molecules, two backbones, a backbone and a network, two networks, etc. An interface may comprise a physical attachment of two parts of matter or components or a physical attraction between two parts of matter or components, including bond forces such as covalent and ionic bonding, and non-bond forces such as Van der Waals, diffusion bonding, electrostatic, coulombic, hydrogen bonding and/or magnetic attraction. Contemplated interfaces include those interfaces that are formed with bond forces, such as covalent bonds; however, it should be understood that any suitable adhesive attraction or attachment between the two parts of matter or components is preferred.

Optimal interface materials and/or components possess a high thermal conductivity and a high mechanical compliance, e.g. will yield elastically when force is applied. High thermal conductivity reduces the first term of Equation 1 while high mechanical compliance reduces the second term. The layered interface materials and the individual components of the layered interface materials described herein accomplish these goals. When properly produced, the thermal interface component described herein will span the distance between the mating surface of the heat spreader material and the silicon die component thereby allowing a continuous high conductivity path from one surface to the other surface.

As mentioned earlier, several goals of layered interface materials and individual components described herein are to: a) design and produce thermal interconnects and thermal interface materials, layered materials, components and products that meet customer specifications while minimizing the size of the device and number of layers; b) produce more efficient and better designed materials, products and/or components with respect to the compatibility requirements of the material, component or finished product; c) develop reliable methods of producing desired thermal interconnect materials, thermal interface materials and layered materials and components/products comprising contemplated thermal interface and layered materials; d) develop materials that possess a high thermal conductivity and a high mechanical compliance; and e) effectively reduce the number of production steps necessary for a package assembly, which in turn results in a lower cost of ownership over other conventional layered materials and processes.

Pre-attached/pre-assembled thermal solutions and/or IC (interconnect) packages are provided herein that comprise one or more components of a suite of thermal interface materials that exhibit low thermal resistance for a wide variety of interface conditions and demands. Thermal interface materials may comprise PCM45 and/or PCM45F, which is a high conductivity phase change material manufactured by Honeywell International Inc., or metal and metal-based base materials also manufactured by Honeywell International Inc., such as solders, connected to Ni, Cu, Al, AlSiC, copper composites, CuW, diamond, graphite, SiC, carbon composites and diamond composites which are classified as heat spreaders or those materials that work to dissipate heat.

The layered interface materials and the individual components of the layered interface materials described herein accomplish these goals. When properly produced, the heat spreader component described herein will span the distance between the mating surfaces of the thermal interface material and the heat spreader component, thereby allowing a continuous high conductivity path from one surface to the other surface.

Components and materials, including thermal transfer materials, contemplated herein comprise at least one heat spreader component coupled with a metal-based coating, layer and/or film, at least one thermal interface material and in some contemplated embodiments at least one adhesive material. The heat spreader component comprises a top surface, a bottom surface and at least one heat spreader material. The thermal interface material is directly deposited onto at least part of at least one of the surfaces of the heat spreader component. In other embodiments, the thermal transfer materials may also comprise protective layers or protective coatings. In contemplated embodiments, the protective layer is designed to transfer a smooth surface to the metal-based coating. Contemplated protective layers comprise stiff plastic, such as PVC or polyethylene. The heat spreader component comprises a top surface, a bottom surface and at least one heat spreader material. The thermal interface material is directly deposited onto at least part of the bottom surface of the heat spreader component.

Heat spreader components or heat spreading components (heat spreader and heat spreading are used herein interchangeably and have the same common meaning) generally comprise a metal, a metal-based base material, a high-conductivity non-metal or combinations thereof, such as nickel, aluminum, copper, copper-tungsten, CuSiC, diamond, silicon carbide, graphite, composite materials such as copper composites, carbon composites and diamond composites or AlSiC and/or other suitable high-conductivity materials that may not comprise metal. Any suitable metal or metal-based base material can be used herein as a heat spreader, as long as the metal or metal-based base-material can dissipate some or all of the heat generated by the electronic component. Specific examples of contemplated heat spreader components are shown under the Examples section.

As used herein, the term “metal” means those elements that are in the d-block and f-block of the Periodic Chart of the Elements, along with those elements that have metal-like properties, such as silicon and germanium. As used herein, the phrase “d-block” means those elements that have electrons filling the 3d, 4d, 5d, and 6d orbitals surrounding the nucleus of the element. As used herein, the phrase “f-block” means those elements that have electrons filling the 4f and 5f orbitals surrounding the nucleus of the element, including the lanthanides and the actinides. Preferred metals include indium, silver, copper, aluminum, tin, bismuth, lead, gallium and alloys thereof, silver coated copper, and silver coated aluminum. The term “metal” also includes alloys, metal/metal composites, metal ceramic composites, metal polymer composites, as well as other metal composites. As used herein, the term “compound” means a substance with constant composition that can be broken down into elements by chemical processes. As used herein, the phrase “metal-based” refers to any coating, film, composition or compound that comprises at least one metal.

Heat spreader components can be laid down in any suitable thickness, depending on the needs of the electronic component, the vendor and as long as the heat spreader component is able to sufficiently perform the task of dissipating some or all of the heat generated from the surrounding electronic component. Contemplated thicknesses comprise thicknesses in the range of about 0.25 mm to about 6 mm. In some embodiments, contemplated thicknesses of heat spreader components are within the range of about 0.5 mm to about 5 mm. In other embodiments, contemplated thicknesses of heat spreader components are within the range of about 1 mm to about 4 mm.

When using a metallic thermal interface material, like solder, which has a high elastic modulus compared to most polymer systems, it may be necessary to reduce coefficient of thermal expansion mismatch generated mechanical stresses transferred to the semiconductor die in order to prevent cracking of the die. This stress transfer can be minimized by increasing the bondline of the metallic thermal interface material, reducing the coefficient of thermal expansion of the heat spreader, or change the geometry of the heat spreader to minimize stress transfer. Examples of lower coefficient of thermal expansion (CTE) materials are AlSiC, CuSiC, copper-graphite composites, carbon-carbon composites, diamond, CuMoCu laminates, etc. Examples of geometric changes are adding a partial or through slot to the spreader to decrease spreader thickness and forming a truncated, square based, inverted pyramid shape to lower stress and stiffness by having the spreader cross-section be lower near the semiconductor die.

As mentioned, the at least one heat spreader component may be coupled with a metal-based coating, layer and/or film. As used herein, the term “coupled” means that the surface and coating, layer and/or film are physically attached to one another or there's a physical attraction between two parts of matter or components, including bond forces such as covalent and ionic bonding, and non-bond forces such as Van der Waals, diffusion bonding, electrostatic, coulombic, hydrogen bonding and/or magnetic attraction. Also, as used herein, the term coupled is meant to encompass a situation where the heat spreader component and the metal-based coating, layer and/or film are directly attached to one another, but the term is also meant to encompass the situation where the heat spreader component and the metal-based coating, layer and/or film are coupled to one another indirectly—such as the case where there's an adhesion promoter layer between the heat spreader component and the metal-based coating, layer and/or film or where there's another layer altogether between the heat spreader component and the metal-based coating, layer and/or film.

In contemplated embodiments, metal-based coating layers may comprise any suitable metal that can be laid down on the surface of the heat spreader in a layer. In some embodiments, the metal-based coating layer comprises indium, such as from indium metal, In33Bi, In33BiGd and In3Ag.

The metal-based coating, layer and/or film is deposited or applied to at least one of the surfaces of the heat spreader component. The metal-based coating, layer and/or film may also be coated onto at least one of the surfaces of the heat spreader component. The terms coating, applied and deposited are used to show that the metal-based coating, film and/or layer can be coated as a liquid or melt, can be applied as a strip, layer or film or can be deposited by vapor deposition, plating or electroplating and any other suitable deposition method.

These metal-based coating layers are generally laid down by any method capable of producing a uniform layer with a minimum of pores or voids and can further lay down the layer with a relatively high deposition rate. Many suitable methods and apparatus are available to lay down layers or ultra thin layers of this type. One contemplated method is spot plating, which is described in the Examples section. Another method is pulsed plating. Pulsed plating (which is intermittent plating as opposed to direct current plating) can lay down layers that are free or virtually free of pores and/or voids.

Another method of laying down thin layers or ultra thin layers is the pulse periodic reverse method or “PPR”. The pulse periodic reverse method goes one step beyond the pulse plating method by actually “reversing” or depleting the film at the cathode surface. A typical cycle for pulse periodic reverse might be 10 ms at 5 amps cathodic followed by 0.5 ms at 10 amps anodic followed by a 2 ms off time. There are several advantages of PPR. First, by “stripping” or deplating a small amount of film during each cycle, PPR forces new nucleation sites for each successive cycle resulting in further reductions in porosity. Second, cycles can be tailored to provide very uniform films by selectively stripping the thick film areas during the “deplating” or anodic portion of the cycle. PPR does not work well for some metal deposition, such as gold deposition, because gold plating is normally done in systems with no free cyanide. Hence gold will plate from a cyanide complex (chelate) during the plate cycle but cannot “strip” during the deplate cycle as there is no cyanide to allow the gold to re-dissolve. Pulse plating and pulse periodic reverse systems can be purchased from any suitable source, such as a company like Dynatronix™ or built (in whole or in part) on site.

The metal-based coatings, layers and/or films for use in the subject matter described herein should be able to be laid down in a thin or ultra thin continuous layer or pattern. The pattern may be produced by the use of a mask or the pattern may be produced by a device capable of laying down a desired pattern. Contemplated patterns include any arrangement of points or dots, whether isolated or combined to form lines, filled-in spaces and so forth. Thus, contemplated patterns include straight and curved lines, intersections of lines, lines with widened or narrowed areas, ribbons, overlapping lines. Contemplated thin layers and ultra thin coating layers may range from less than about 1 μm down to about one Angstrom or even down to the size of a single atomic layer of material. Specifically, some contemplated thin layers are less than about 1 μm thick. In other embodiments, contemplated thin layers are less than about 500 nm thick. In some embodiments, contemplated ultra thin layers are less than about 100 nm thick. In yet other embodiments, contemplated ultra thin layers are less than about 10 nm thick.

In contemplated embodiments, the thermal interface material is directly deposited onto at least one of the sides of the heat spreader component, such as the bottom side, the top side or both. In some contemplated embodiments, the solder material is silk screened or dispensed directly onto the heat spreader by methods such as jetting, thermal spray, liquid molding or powder spray. In yet other contemplated embodiments, a film of thermal interface material is deposited and combined with other methods of building adequate thermal interface material thickness, including direct attachment of a preform or silk screening of a thermal interface material paste.

Methods of forming layered thermal interface materials and thermal transfer materials include: a) providing a heat spreader component, wherein the heat spreader component comprises a top surface, a bottom surface and at least one heat spreader material; b) providing at least one thermal interface material, wherein the thermal interface material is directly deposited onto the bottom surface of the heat spreader component; c) depositing, applying or coating a metal-based coating, film or layer on at least part of the bottom surface of the heat spreader component; and d) depositing, applying or coating the at least one thermal interface material onto at least part of at least one of the surfaces of the heat spreader component.

Once deposited, applied or coated, the thermal interface material layer comprises a portion that is directly coupled to the heat spreader material and a portion that is exposed to the atmosphere, or covered by a protective layer or film that can be removed just prior to installation of the heat spreader component. Additional methods include providing at least one adhesive component and coupling the at least one adhesive component to at least part of at least one of the surfaces of the at least one heat spreader material and/or to or in at least part of the thermal interface material. At least one additional layer, including a substrate layer, can be coupled to the layered interface material.

As described herein, optimal interface materials and/or components possess a high thermal conductivity and a high mechanical compliance, e.g. will yield elastically when force is applied. High thermal conductivity reduces the first term of Equation 1 while high mechanical compliance reduces the second term. The layered interface materials and the individual components of the layered interface materials described herein accomplish these goals. When properly produced, the heat spreader component described herein will span the distance between the mating surfaces of the thermal interface material and the heat spreader component thereby allowing a continuous high conductivity path from one surface to the other surface. Suitable thermal interface components comprise those materials that can conform to the mating surfaces (“wets” the surface), possess a low bulk thermal resistance and possess a low contact resistance.

A suitable interface material can also be produced/prepared that comprises a solder material. The solder material may comprise any suitable solder material or metal, such as indium, silver, copper, aluminum, tin, bismuth, lead, gallium and alloys thereof, silver coated copper, and silver coated aluminum, but it is preferred that the solder material comprise indium or indium-based alloys. Suitable interface materials may comprise a conductive filler, a metallic material, a solder alloy and combinations thereof.

The solder-based interface materials, as described herein, have several advantages directly related to use and component engineering, such as: a) high bulk thermal conductivity, b) metallic bonds may be formed at the joining surfaces, lower contact resistance c) the interface solder material can be easily incorporated into micro components, components used for satellites, and small electronic components.

An additional component, such as a low modulus metal coated polymer sphere or microspheres may be added to the solder material to decrease the bulk elastic modulus of the solder. An additional component may also be added to the solder to promote wetting to the die and/or heat spreader surface. These additions are contemplated to be silicide formers, or elements that have a higher affinity for oxygen or nitrogen than does silicon. The additions can be one element that satisfies all requirements, or multiple elements each of which has one advantage. Additionally, alloying elements may be added which increase the solubility of the dopant elements in the indium or solder matrix.

Thermal filler particles may be dispersed in the thermal interface component or mixture should advantageously have a high thermal conductivity. Suitable filler materials include metals, such as silver, copper, aluminum, and alloys thereof; and other compounds, such as boron nitride, aluminum nitride, silver coated copper, silver-coated aluminum, conductive polymers and carbon fibers. Combinations of boron nitride and silver or boron nitride and silver/copper also provide enhanced thermal conductivity. Boron nitride in amounts of at least 20 wt % and silver in amounts of at least about 60 wt % are particularly useful. Preferably, fillers with a thermal conductivity of greater than about 20 and most preferably at least about 40 W/m° C. can be used. Optimally, it is desired to have a filler of not less than about 80 W/m° C. thermal conductivity.

Another contemplated and suitable thermal interface material can be produced/prepared that comprises a resin mixture and at least one solder material. The resin material may comprise any suitable resin material, but it is preferred that the resin material be silicone-based comprising one or more compounds such as vinyl silicone, vinyl Q resin, hydride functional siloxane and platinum-vinylsiloxane. The solder material may comprise any suitable solder material or metal, such as indium, silver, copper, aluminum, tin, bismuth, lead, gallium and alloys thereof, silver coated copper, and silver coated aluminum, but it is preferred that the solder material comprise indium or indium-based alloys.

The solder-based interface materials, such a polymer solder materials, polymer solder hybrid materials and other solder-based interface materials, as described herein, have several advantages directly related to use and component engineering, such as: a) the interface material/polymer solder material can be used to fill small gaps on the order of 2 millimeters or smaller, b) the interface material/polymer solder material can efficiently dissipate heat in those very small gaps as well as larger gaps, unlike most conventional solder materials, and c) the interface material/polymer solder material can be easily incorporated into micro components, components used for satellites, and small electronic components.

Resin-containing interface materials and solder materials, especially those comprising silicone resins, that may also have appropriate thermal fillers can exhibit a thermal capability of less than 0.5° C.-cm²/W. Unlike thermal grease, thermal performance of the material will not degrade after thermal cycling or flow cycling in IC devices because liquid silicone resins will cross link to form a soft gel upon heat activation.

Interface materials and polymer solders comprising resins, such as silicone resins, will not be “squeezed out” as thermal grease can be in use and will not display interfacial delamination during thermal cycling. The new material can be provided as a dispensable liquid paste to be applied by dispensing methods and then cured as desired. It can also be provided as a highly compliant, cured, and possibly cross-linkable elastomer film or sheet for pre-application on interface surfaces, such as heat sinks. Advantageously, fillers with a thermal conductivity of greater than about 20 and preferably at least about 40 W/m° C. will be used. Optimally, it is desired to have a filler of not less than about 100 W/m° C. thermal conductivity. The interface material enhances thermal dissipation of high power semiconductor devices. The paste may be formulated as a mixture of functional silicone resins and thermal fillers.

A vinyl Q resin is an activated cure specialty silicone rubber having the following base polymer structure:

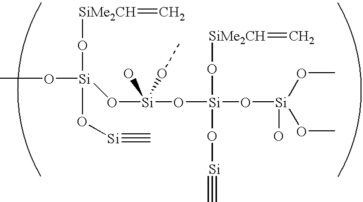

Vinyl Q resins are also clear reinforcing additives for addition cure elastomers. Examples of vinyl Q resin dispersions that have at least 20% Q-resin are VQM-135 (DMS-V41 Base), VQM-146 (DMS-V46 Base), and VQX-221 (50% in xylene Base).

As an example, a contemplated silicone resin mixture could be formed as follows:

| Component | % by weight | Note/Function |
|---|---|---|
| Vinyl silicone | 75 (70-97 range) | Vinyl terminated siloxane |
| Vinyl Q Resin | 20 (0-25 range) | Reinforcing additive |
| Hydride functional | 5 (3-10 range) | Crosslinker |
| siloxane | | |
| Platinum- | 20-200 ppm | Catalyst |
| vinylsiloxane | | |

The resin mixture can be cured at either at room temperature or at elevated temperatures to form a compliant elastomer. The reaction is via hydrosilylation (addition cure) of vinyl functional siloxanes by hydride functional siloxanes in the presence of a catalyst, such as platinum complexes or nickel complexes. Preferred platinum catalysts are SIP6830.0, SIP6832.0, and platinum-vinylsiloxane.

Contemplated examples of vinyl silicone include vinyl terminated polydimethyl siloxanes that have a molecular weight of about 10000 to 50000. Contemplated examples of hydride functional siloxane include methylhydrosiloxane-dimethylsiloxane copolymers that have a molecular weight about 500 to 5000. Physical properties can be varied from a very soft gel material at a very low crosslink density to a tough elastomer network of higher crosslink density.

Solder materials that are dispersed in the resin mixture are contemplated to be any suitable solder material for the desired application. Preferred solder materials are indium tin (InSn) alloys, indium silver (InAg) alloys, indium-bismuth (InBi) alloys, indium-based alloys, tin silver copper alloys (SnAgCu), tin bismuth and alloys (SnBi), and aluminum-based compounds and alloys. Especially preferred solder materials are those materials that comprise indium. The solder may or may not be doped with additional elements to promote wetting to the heat spreader or die backside surfaces.

As with the previously described thermal interface materials and components, thermal filler particles may be dispersed in the resin mixture. If thermal filler particles are present in the resin mixture, then those filler particles should advantageously have a high thermal conductivity. Suitable filler materials include silver, copper, aluminum, and alloys thereof; boron nitride, aluminum spheres, aluminum nitride, silver coated copper, silver coated aluminum, carbon fibers, and carbon fibers coated with metals, metal alloys, conductive polymers or other composite materials. Combinations of boron nitride and silver or boron nitride and silver/copper also provide enhanced thermal conductivity. Boron nitride in amounts of at least 20 wt. %, aluminum spheres in amounts of at least 70 wt. %, and silver in amounts of at least about 60 wt. % are particularly useful. These materials may also comprise metal flakes or sintered metal flakes.

Vapor grown carbon fibers, as previously described, and other fillers, such as substantially spherical filler particles may be incorporated. Additionally, substantially spherical shapes or the like will also provide some control of the thickness during compaction. Dispersion of filler particles can be facilitated by the addition of functional organo metallic coupling agents or wetting agents, such as organosilane, organotitanate, organozirconium, etc. The organo metallic coupling agents, especially organotitanate, may also be used to facilitate melting of the solder material during the application process. Typical particle sizes useful for fillers in the resin material may be in the range of about 1-20 μm with a maximum of about 100 μm.

These compounds may comprise at least some of the following: at least one silicone compound in 1 to 20 weight percent, organotitanate in 0-10 weight percent, at least one solder material in 5 to 95 weight percent. These compounds may include one or more of the optional additions, e.g., wetability enhancer. The amounts of such additions may vary but, generally, they may be usefully present in the following approximate amounts (in wt. %): filler up to 95% of total (filler plus resins); wetability enhancer 0.1 to 5% (of total); and adhesion promoters 0.01 to 1% (of total). It should be noted the addition at least about 0.5% carbon fiber significantly increases thermal conductivity. These compositions are described in U.S. Issued Pat. No. 6,706,219, U.S. application Ser. No.: 10/775989 filed on Feb. 9, 2004 and PCT Serial No.: PCT/US02/14613, which are all commonly owned and incorporated herein in their entirety by reference.

Contemplated solder compositions are as follows: InSn=52% In (by weight) and 48% Sn (by weight) with a melting point of 118° C.; InAg=97% In (by weight) and 3% Ag (by weight) with a melting point of 143° C.; In=100% indium (by weight) with a melting point of 157° C.; SnAgCu=94.5% tin (by weight), 3.5% silver (by weight) and 2% copper (by weight) with a melting point of 217° C.; SnBi=60% Tin (by weight) and 40% bismuth (by weight) with a melting point of 170° C. It should be appreciated that other compositions comprising different component percentages can be derived from the subject matter contained herein.

Phase-change materials that are contemplated herein comprise waxes, polymer waxes or mixtures thereof, such as paraffin wax. Paraffin waxes are a mixture of solid hydrocarbons having the general formula CₙH₂ₙ₊₂ and having melting points in the range of about 20° C. to 100° C. Examples of some contemplated melting points are about 45° C. and 60° C. Thermal interface components that have melting points in this range are PCM45 and PCM60HD—both manufactured by Honeywell International Inc. Polymer waxes are typically polyethylene waxes, polypropylene waxes, and have a range of melting points from about 40° C. to 160° C.

PCM45 comprises a thermal conductivity of about 3.0 W/mK, a thermal resistance of about 0.25° C.-cm²/W, is typically applied at a thickness of about 0.0015 inches (0.04 mm) and comprises a soft material, flowing easily under an applied pressure of about 5 to 30 psi. Typical characteristics of PCM45 are a) a super high packaging density—over 80%, b) a conductive filler, c) extremely low thermal resistance, and as mentioned earlier d) about a 45° C. phase change temperature. PCM60HD comprises a thermal conductivity of about 5.0 W/mK, a thermal resistance of about 0.17° C.-cm²/W, is typically applied at a thickness of about 0.0015 inches (0.04 mm) and comprises a soft material, flowing easily under an applied pressure of about 5 to 30 psi. Typical characteristics of PCM60HD are a) a super high packaging density—over 80%, b) a conductive filler, c) extremely low thermal resistance, and as mentioned earlier d) about a 60° C. phase change temperature. TM350 (a thermal interface component not comprising a phase change material and manufactured by Honeywell International Inc.) comprises a thermal conductivity of about 3.0 W/mK, a thermal resistance of about 0.25° C.-cm²/W, is typically applied at a thickness of about 0.0015 inches (0.04 mm) and comprises a paste that can be thermally cured to a soft gel. Typical characteristics of TM350 are a) a super high packaging density—over 80%, b) a conductive filler, c) extremely low thermal resistance, d) about a 125° C. curing temperature, and e) dispensable non-silicone-based thermal gel. PCM45F comprises a thermal conductivity of about 2.35 W/mK, a thermal resistance of about 0.20° C.-cm²/W, is typically applied at a thickness of about 0.002 mm and comprises a soft material, flowing easily under an applied pressure of about 5 to 40 psi. Typical characteristics of PCM45F are a) a super high packaging density—over 80%, b) a conductive filler, c) extremely low thermal resistance, and as mentioned earlier d) about a 45° C. phase change temperature.

Phase change materials are useful in thermal interface component applications because they are solid at room temperature and can easily be pre-applied to thermal management components. At operation temperatures above the phase change temperature, the material is liquid and behaves like a thermal grease. The phase change temperature is the melting temperature at which the heat absorption and rejection takes place.

Paraffin-based phase change materials, however, have several drawbacks. On their own, they can be very fragile and difficult to handle. They also tend to squeeze out of a gap from the device in which they are applied during thermal cycling, very much like grease. The rubber-resin modified paraffin polymer wax system described herein avoids these problems and provides significantly improved ease of handling, is capable of being produced in flexible tape or solid layer form, and does not pump out or exude under pressure. Although the rubber-resin-wax mixtures may have the same or nearly the same temperature, their melt viscosity is much higher and they do not migrate easily. Moreover, the rubber-wax-resin mixture can be designed to be self-crosslinking, which ensures elimination of the pump-out problem in certain applications. Examples of contemplated phase change materials are malenized paraffin wax, polyethylene-maleic anhydride wax, and polypropylene-maleic anhydride wax. The rubber-resin-wax mixtures will functionally form at a temperature between about 50 to 150° C. to form a crosslinked rubber-resin network.

The contemplated thermal interface component can be provided as a dispensable liquid paste to be applied by dispensing methods (such as screen printing or stenciling) and then cured as desired. It can also be provided as a highly compliant, cured, elastomer film or sheet for pre-application on interface surfaces, such as heat sinks. It can further be provided and produced as a soft gel or liquid that can be applied to surfaces by any suitable dispensing method, such as screen-printing or ink jet printing. Even further, the thermal interface component can be provided as a tape that can be applied directly to interface surfaces or electronic components.

Pre-attached/pre-assembled thermal solutions and/or IC (interconnect) packages comprise one or more components of the thermal interface materials described herein and at least one adhesive component. These thermal interface materials exhibit low thermal resistance for a wide variety of interface conditions and demands. As used herein, the term “adhesive component” means any substance, inorganic or organic, natural or synthetic, that is capable of bonding other substances together by surface attachment. In some embodiments, the adhesive component may be added to or mixed with the thermal interface material, may actually be the thermal interface material or may be coupled, but not mixed, with the thermal interface material. Examples of some contemplated adhesive components comprise double-sided tape from SONY, such as SONY T4411, 3M F9460PC or SONY T4100D203. In other embodiments, the adhesive may serve the additional function of attaching the heat spreading component to the package substrate independent of the thermal interface material.

The thermal interface components, the crosslinkable thermal interface components and the heat spreader components can be individually prepared and provided by using the methods previously described herein. The two components are then physically coupled to produce a layered interface material. As used herein, the term “interface” means a couple or bond that forms the common boundary between two parts of matter or space. An interface may comprise a physical attachment or physical couple of two parts of matter or components or a physical attraction between two parts of matter or components, including bond forces such as covalent and ionic bonding, and non-bond forces such as Van der Waals, electrostatic, coulombic, hydrogen bonding and/or magnetic attraction. The two components, as described herein, may also be physically coupled by the act of applying one component to the surface of the other component.

The layered interface material may then be applied to a substrate, another surface, or another layered material. The electronic component comprises a layered interface material, a substrate layer and an additional layer. The layered interface material comprises a heat spreader component and a thermal interface component. Substrates contemplated herein may comprise any desirable substantially solid material. Particularly desirable substrate layers would comprise films, glass, ceramic, plastic, metal or coated metal, or composite material. In preferred embodiments, the substrate comprises a silicon or germanium arsenide die or wafer surface, a packaging surface such as found in a copper, silver, nickel or gold plated leadframe, a copper surface such as found in a circuit board or package interconnect trace, a via-wall or stiffener interface (“copper” includes considerations of bare copper and it's oxides), a polymer-based packaging or board interface such as found in a polyimide-based flex package, lead or other metal alloy solder ball surface, glass and polymers such as polymimide. The “substrate” may even be defined as another polymer material when considering cohesive interfaces. In more preferred embodiments, the substrate comprises a material common in the packaging and circuit board industries such as silicon, copper, glass, and another polymer.

Additional layers of material may be coupled to the layered interface materials in order to continue building a layered component or printed circuit board. It is contemplated that the additional layers will comprise materials similar to those already described herein, including metals, metal alloys, composite materials, polymers, monomers, organic compounds, inorganic compounds, organometallic compounds, resins, adhesives and optical wave-guide materials.

Several methods and many thermal interface materials can be utilized to form these pre-attached/pre-assembled thermal solution components. A method for forming the thermal solution/package and/or IC package includes: a) providing the thermal transfer material described herein; b) providing at least one adhesive component; c) providing at least one surface or substrate; d) coupling the at least one thermal transfer material and/or material with the at least one adhesive component to form an adhesive unit; e) coupling the adhesive unit to the at least one surface or substrate to form a thermal package; f) optionally coupling an additional layer or component to the thermal package.

Applications of the contemplated thermal solutions, IC Packages, thermal interface components, layered interface materials and heat spreader components described herein comprise incorporating the materials and/or components into another layered material, an electronic component or a finished electronic product. Electronic components, as contemplated herein, are generally thought to comprise any layered component that can be utilized in an electronic-based product. Contemplated electronic components comprise circuit boards, chip packaging, separator sheets, dielectric components of circuit boards, printed-wiring boards, and other components of circuit boards, such as capacitors, inductors, and resistors.

### EXAMPLES

As contemplated herein, one method of applying the at least one metal-based coating is by spot plating, which is the application of a metal-based coating to the surface of the barrier layer (Ni), on a copper heat spreader. Spot plating is conducted with electrolytic plating usually in the desired area for solder or solder polymer hybrid TIMs (thermal interface materials) attachment. Spot plated areas can be sized to customer specs and the thickness of the coating can be equal to or less than about 15 micron. In this Example, the metal-based coating comprises indium.

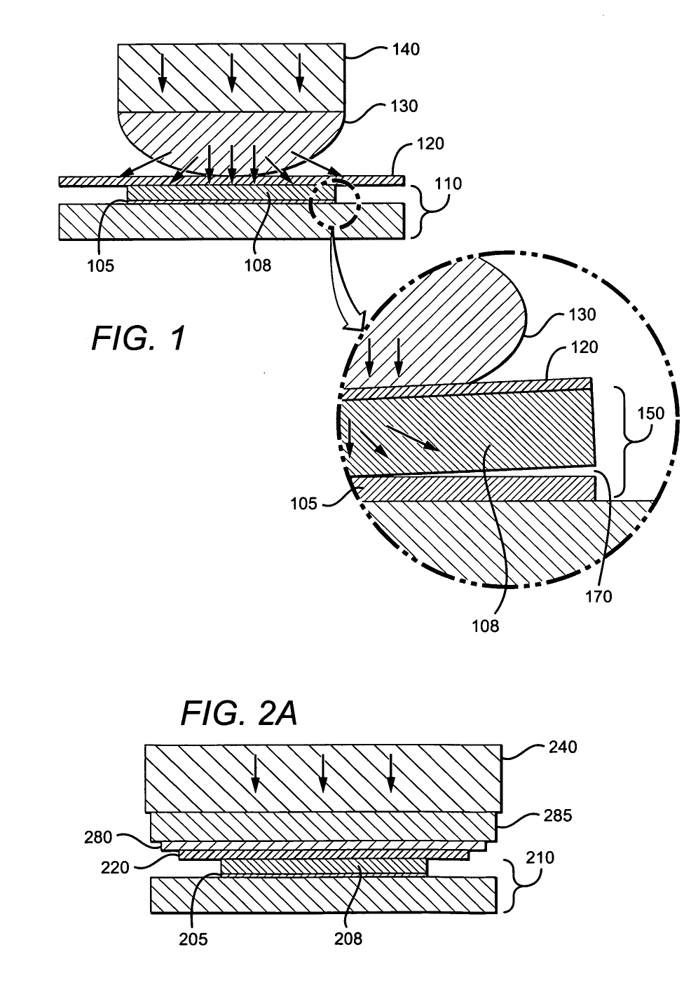

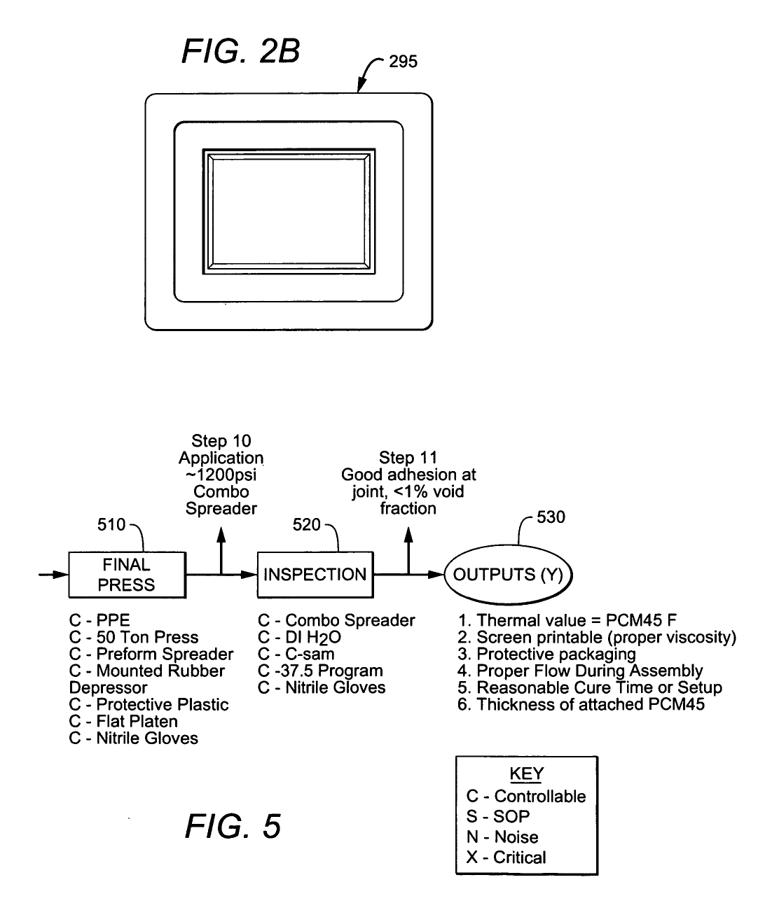

Manufacturing of a TIM 1 metal-based combo spreader comprises a step-press process. (see FIGS. 1 and 2A) This process starts with a pre-form and an indium spot-plated spreader (the indium spot shown in FIG. 1 as 105 and indium layer shown in FIG. 1 as 108) of which have gross oxides removed from each and then placed together (110). After this initial placement the assembly is then placed into a press. The assembly in the press is accompanied by one layer of a smooth protection layer (120) that is then pressed with a compliant material (130) by a press ram (140) that initiates the compression in the center of the pre-form (150). Once the protection layer (120) encompasses the entire pre-form (110) any air pockets (170) that may be trapped from initial pre-form application should be removed. In FIG. 1, the first application of pressure is done to eliminate as many voids that may be present at the interface of the In preform and the spot plated surface. The compliant material will apply vertical forces as well as the Indium movement across the spot plated surface creating a sheer force that will aid adhesion at this junction.

Following the addition of a protection layer a second press is then applied with a protective layer over the In pre-form followed by a second layer of compliant material followed by a third layer of stiff material, which contacts the press ram. FIG. 2A shows the assembly (200) used for the second and third press. A press ram (240) initiates the compression of the layers of material, which includes an indium spot (205) in this embodiment. The stiff material (285) helps to maintain even contact to the compliant material to distribute the load evenly. The protective plastic layer (220) will give the indium (208) a smooth and polished finish as seen on the right. The compliant material (280) allows some sheer movement of the indium pre-form (210), which comprises the heat spreader (290) but will contain it from over flowing into a non desired area of the heat spreader (225). This second assembly is then exposed to a second press application followed by a third press to obtain desired results. This press application will further cold welding of the In spot plate and the In pre-form. FIG. 2B shows the finished heat spreader comprising the indium preform (295).

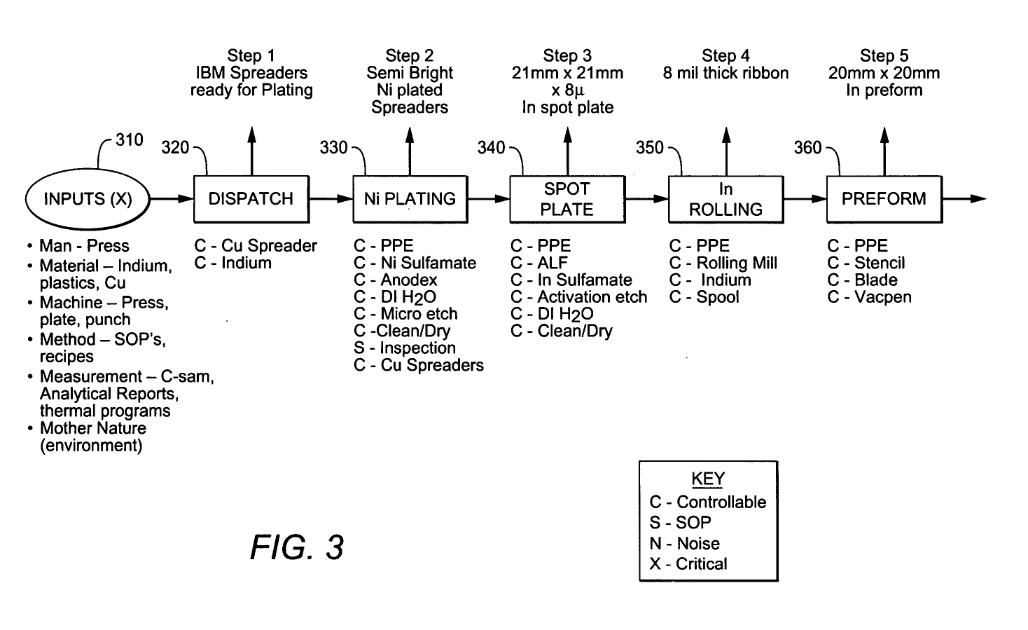

FIGS. 3-5 show a contemplated process map (in three parts) for producing an indium combo spreader. The key for all three Figures is shown, wherein “C” is a controllable, “S” is a standard operating procedure, “N” is noise and “X” is critical. Contemplated inputs (310) are shown in FIG. 3, which are provided to the process before the process steps are started. Step 1 (320) shows that the contemplated spreaders are ready for plating and are dispatched to the process. Step 2 (330) comprises nickel plating of the spreaders. In step 3 (340), the metal-based coating, layer or film is applied—which is an indium spot in this embodiment. In step 4 (350), an indium layer preform is rolled out. This indium layer preform can be seen as numbers 108 and 208 in FIGS. 1 and 2, respectively. In step 5 (360), the preform is formed.

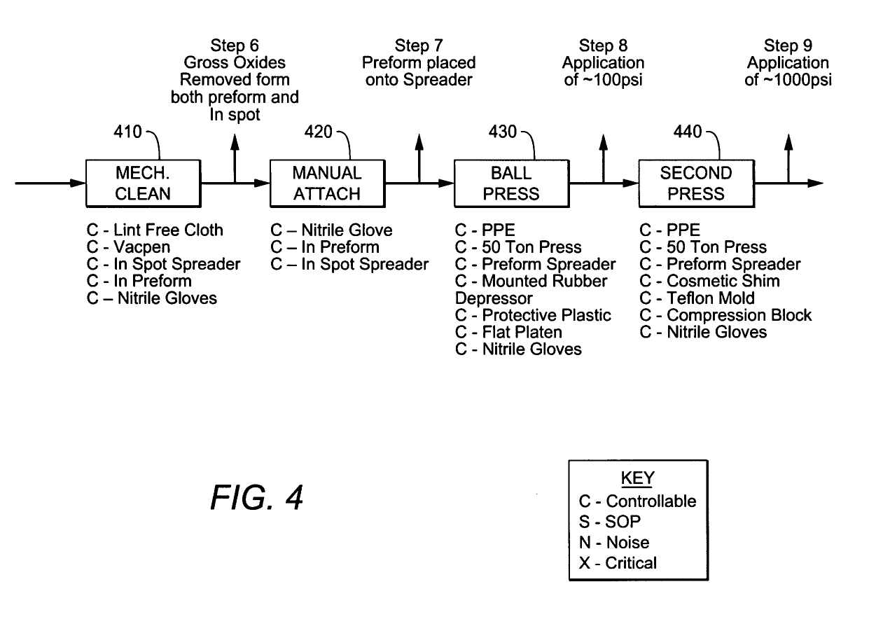

FIG. 4 shows part 2 of a contemplated process map. Step 6 (410) comprises mechanically cleaning the indium preform and the indium spot. With a mechanically cleaned indium coated nickel plated heat spreader and mechanically cleaned indium perform the press steps are to follow. Step 7 (420) comprises placing the indium preform onto the nickel-plated spreader. The cleaned preform is placed onto the cleaned indium coated nickel plated heat spreader in the desired area. Then a cosmetic and protective layer of plastic is placed onto the top surface of the indium preform. Step 8 (430) comprises the first press step, as discussed herein. The press application then is conducted at >40 psi with the compliant process to remove air from the indium and indium coated nickel plated heat spreader joint. When the compliant material has covered the entire surface of the preform the air will be sufficiently removed from the joint. Step 9 (440) comprises the second press step, also as discussed herein. After the compliant press the assembly is ready for the second press to firmly attach the indium preform to the indium coated nickel plated heat spreader. A layer of cosmetic transferal material is placed onto the indium preform followed by a layer of compliant Teflon that will retain the desired shape. A stiff material is then placed on the compliant Teflon to retain the flatness of the preform during pressing.

FIG. 5 shows part 3 of a contemplated process map. Step 10 (510) comprises an additional press step to form the combo-spreader. This assembly is then pressed at higher pressure >500 psi to securely attach the indium preform. The third press application is then conducted to promote the fusion of the indium preform and the indium coating on the nickel plated heat spreader. The same assembly applies to the third press as it does for the second press. This assembly is then pressed >1000 psi load to achieve the fusion at the joint. With this third press the part can have the flatness and roughness controlled by substituting materials that make up the press assembly. More press steps can be added to achieve desired dimensional results. Step 11 (520) is an inspection step. Outputs 530 show the characteristics and expectations of the finished combo-spreader, as also shown in FIG. 2B.

### Example 2

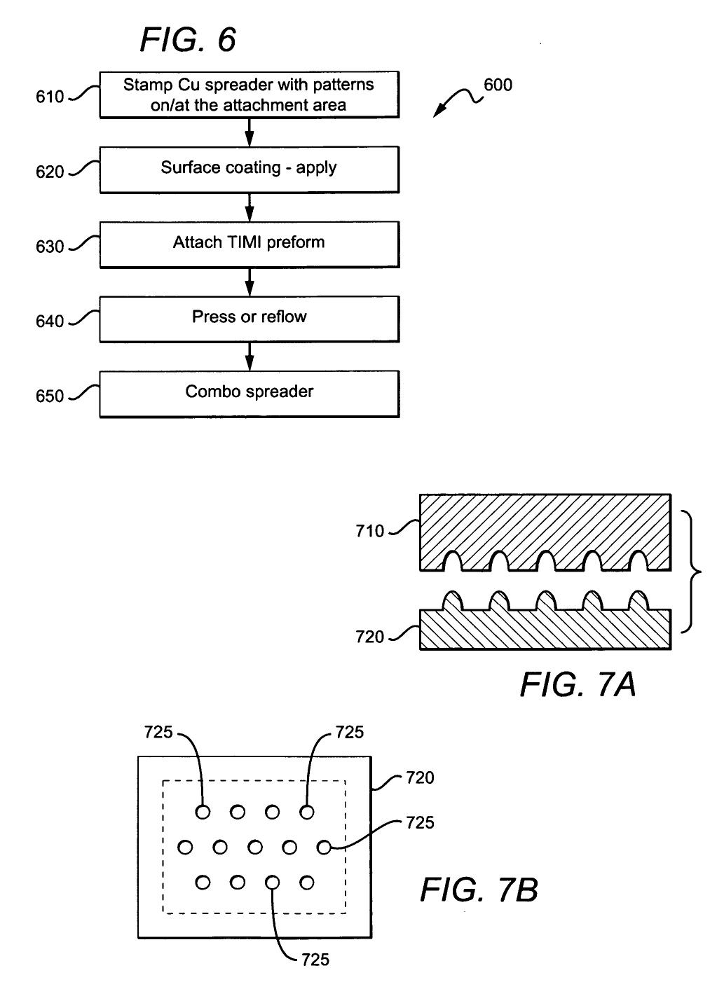

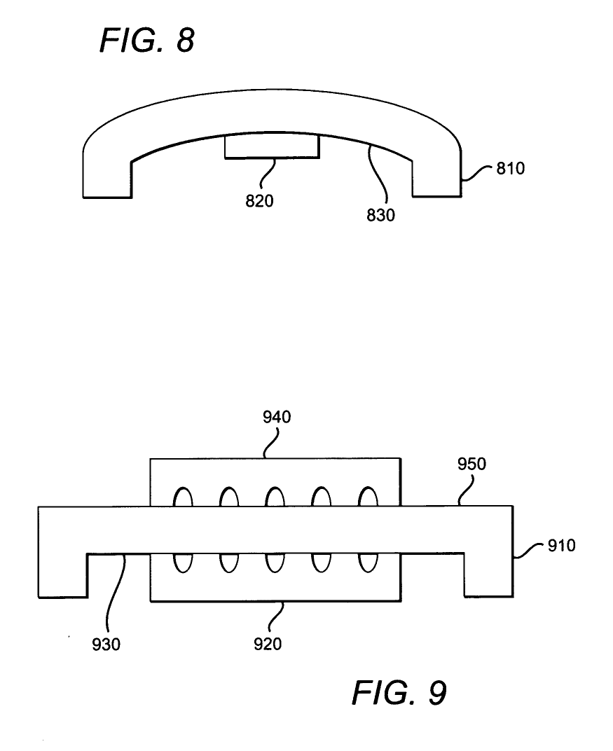

Contemplated combo-spreaders can also be formed with stamping or stamped patterns. FIG. 6 shows a process flow chart and schematics (600) for one of these contemplated embodiments. According to this embodiment, copper spreaders are stamped with patterns on the attachment area (610). The surface is then coated, as previously described (620). A TIM1 preform is attached (630), which comprises polymers, silicon, indium or other solders. The press or reflow process is then completed (640) thereby forming a combo-spreader (650). The advantages to this type of stamped combo-spreader is a) improved surface wettability, b) improved thermal conductivity because of reduced attachment thickness, c) breaking surface oxides during bonding and d) reducing cleaning costs. FIG. 7A shows a stamping die (710) and a contemplated spreader (720). FIG. 7B shows the contemplated spreader (720) after the stamping process has been completed. Note the stamped sections of the spreader (725). FIGS. 8 and 9 show additional contemplated configurations for combo-spreaders that may be utilized. FIG. 8 shows a heat spreader (810) having one thermal interface material layer (820) attached to the bottom concave surface (830). FIG. 9 shows another contemplated heat spreader (910) having one thermal interface material layer (920) attached to the bottom surface (930) and an additional thermal interface material (940) attached to the top surface (950).

Thus, specific embodiments and applications of thermal solutions, IC packaging, thermal interconnect and interface materials have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A thermal transfer material, comprising:
a heat spreader component, wherein the heat spreader component comprises a top surface, a bottom surface and at least one heat spreader material, wherein
at least one surface is coupled with a metal-based coating, layer or film, and
at least one thermal interface material, wherein the thermal interface material is deposited onto at least one surface of the heat spreader component.

2. The thermal transfer material of claim 1, wherein the thermal material is further coupled to a substrate.

3. The thermal transfer material of claim 2, wherein the substrate comprises silicon.

4. The thermal transfer material of claim 1, wherein the thermal transfer material further comprises at least one adhesive component.

5. The thermal transfer material of claim 4, wherein the at least one adhesive component is coupled to the heat spreader component.

6. The thermal transfer material of claim 4, wherein the at least one adhesive component is coupled to the thermal interface material.

7. The thermal transfer material of claim 4, wherein the at least one adhesive component is mixed into at least some of the thermal interface material.

8. The thermal transfer material of claim 1, wherein the heat spreader component comprises a metal, a metal-based material, a high-conductivity non-metal or combination thereof.

9. The thermal transfer material of claim 8, wherein the heat spreader component comprises nickel, aluminum, copper or a combination thereof.

10. The thermal transfer material of claim 8, wherein the metal-based material or high-conductive non-metal comprises silicon, carbon, copper, graphite, diamond or a combination thereof.

11. The thermal transfer material of claim 10, wherein the heat spreader component comprises a thickness of about 0.25 mm to about 6 mm.

12. The thermal transfer material of claim 11, wherein the thickness is from about 0.5 mm to about 5 mm.

13. The thermal transfer material of claim 1, wherein the metal-based coating, layer or film comprises indium.

14. The thermal transfer material of claim 1, wherein the metal-based coating, layer or film is coupled to at least part of at least one surface of the heat spreader component.

15. The thermal transfer material of claim 14, wherein the metal-based coating, layer or film comprises a pattern on the at least one surface of the heat spreader component.

16. The thermal transfer material of claim 1, wherein the thermal interface material comprises a phase change material.

17. A method of forming a thermal transfer material, comprising:
providing a heat spreader component, wherein the heat spreader component comprises
a top surface, a bottom surface and at least one heat spreader material, wherein at least one surface is coupled with a metal-based coating, layer or film;
providing at least one thermal interface material, wherein the thermal interface material is deposited onto at least one surface of the heat spreader component; and
depositing the at least one thermal interface material onto the at least one surface of the heat spreader component.

18. The method of claim 17, wherein the thermal transfer material further comprises at least one adhesive component.

19. The method of claim 18, wherein the at least one adhesive component is coupled to the heat spreader component.

20. The method of claim 18, wherein the at least one adhesive component is coupled to the thermal interface material.

21. The method of claim 18, wherein the at least one adhesive component is mixed into at least of the thermal interface material.

22. The method of claim 17, wherein the heat spreader component comprises a metal, a metal-based material, a high-conductivity non-metal or a combination thereof.

23. The method of claim 22, wherein the heat spreader component comprises nickel, aluminum, copper or a combination thereof.

24. The method of claim 22, wherein the metal-based material or high-conductive non-metal comprises silicon, carbon, copper, graphite, diamond or a combination thereof.

25. The method of claim 17, wherein the heat spreader component comprises a thickness of about 0.25 mm to about 6 mm.

26. The method of claim 25, wherein the thickness is from about 0.5 mm to about 5 mm.

27. The method of claim 17, wherein the metal-based coating, layer or film comprises indium.

28. The method of claim 17, wherein the metal-based coating, layer or film is coupled to at least part of at least one surface of the heat spreader component.

29. The method of claim 28, wherein the metal-based coating, layer or film comprises a pattern on the at least one surface of the heat spreader component.

30. The method of claim 17, wherein the thermal interface material comprises a phase change material.

31. A method for forming an IC package, comprising:
providing a thermal transfer material comprising at least one heat spreader component, at least one metal-based coating, layer or film, and at least one thermal interface material;
providing at least one adhesive component;
providing at least one surface or substrate;
coupling the at least one thermal transfer material with the at least one adhesive component to form an adhesive unit; and
coupling the adhesive unit to the at least one surface or substrate to form a thermal package.

32. The method of claim 31, further comprising coupling an additional layer or component to the thermal package.

33. The method of claim 31, wherein the thermal transfer material comprises the thermal transfer material of claim 1.
